(19) United States
(12) Patent Application Publication
(10) Pub. No.: US 2011/0120849 A1
(43) Pub. Date: May 26, 2011

(54) OPERATION INPUT DEVICE AND ELECTRONIC DEVICE USING THE SAME

(75) Inventors: Masaru Morimoto, Shiga (JP); Masayuki Tanaka, Kyoto (JP); Katsumi Edo, Osaka (JP)

(73) Assignee: OMRON CORPORATION, Kyoto-shi, Kyoto (JP)

(21) Appl. No.: 12/674,482

(22) PCT Filed: Dec. 2, 2008
(86) PCT No.: PCT/JP2008/071872

§ 371 Date: Feb. 22, 2010

(30) Foreign Application Priority Data
Mar. 17, 2008 (JP) 2008-068365

(51) Int. Cl. H01H 13/76

(52) U.S. Cl. 200/5 A

(57) ABSTRACT

An operation input device includes a base including at least four elastic engagement receiving portions raised at a periphery of a center thereof; a print substrate configured to be stacked and integrated on the base; an annular operation plate mounted on push button switches of the print substrate and configured to prevent slip-out; an operation dial mounted on the annular operation plate on an axial center; and a fixing tool configured to be inserted to a fit-in hole of the operation hole and engage with at least two elastic engagement receiving portions of the base at an edge on a lower side and with an inner peripheral edge of the operation dial.

### BACKGROUND OF THE INVENTION

1. Technical Field

The present invention relates to an operation input device that can be applied to a mobile phone and a portable music player.

2. Related Art

Conventionally, an operation input device incorporated in a mobile phone and the like includes an operation input device including a base, a print substrate, in which a plurality of push button switches and a magnetic field detection element is mounted on the upper surface and stacked on the base to be integrated, an operation plate supported by the base so as to be movable in the up and down direction on the print substrate, a disc-shaped operation dial having an annular magnet, in which an N pole and an S pole are alternately arranged, assembled to the lower surface and being assembled to the upper surface of the operation plate in a freely turning manner, where the change in the magnetic flux of the annular magnet is detected by the magnetic field detection element to detect the turning direction by turning the disc-shaped operation dial, and the push button switch is operated through the operation plate by pushing the disc-shaped operation dial (see Japanese Unexamined Patent Publication No. 2006-285743).

In such operation input device, an elastic nail 55 arranged at the outer peripheral edge of the operation plate 50 is engaged and assembled to an elastic engagement receiving portion 13 raised from the outer peripheral edge of a metal base 10, as shown in FIG. 4 of Japanese Unexamined Patent Publication No. 2006-285743.

### SUMMARY

However, in such operation input device, the elastic nail 55 tends to easily be caught at the time of transportation or at the time of assembly since it is exposed. Thus, the elastic nail 55 tends to be easily damaged when an external force is applied at the time of transportation, and the like.

The present invention has been devised to solve the problems described above, and an object thereof is to provide an operation input device that is less likely to be damaged at the time of transportation and at the time of assembly.

In accordance with one aspect of the present invention, an operation input device is provided which includes: a base in which at least four elastic engagement receiving portions are raised at the periphery of a center; a print substrate, in which a plurality of push button switches is mounted on the same circumference and a magnetic field detection element is mounted, being stacked and integrated on the base; an annular operation plate for preventing slip-out by engaging an inner peripheral edge to at least two of the elastic engagement receiving portions of the base, and being mounted on the push button switches of the print substrate; an operation dial having an annular magnet integrated on a concentric circle at a lower surface, and being mounted on the annular operation plate on the same axial center; and a fixing tool, being inserted to a fit-in hole of the operation hole and engaged to at least two of the elastic engagement receiving portions of the base at an edge on a lower side, for engaging the inner peripheral edge of the operation dial to prevent slip-out; wherein change in magnetic flux of the annular magnet is detected by the magnetic field detection element when the operation dial is turned, and the push button switch is operated through the operation plate when the operation dial is pushed down.

According to the present invention, the inner peripheral edge of the annular operation dial is engaged to the elastic engagement receiving portion raised from the periphery of the center of the base to prevent slip-out. Thus, the elastic engagement receiving portion does not expose to the exterior as in the prior art, and thus is not caught at the time of transportation and at the time of assembly. As a result, the elastic engagement receiving portion will not be damaged even if an external force is applied at the time of transportation, and the yield is high.

In particular, since the elastic engagement receiving portion is not raised from the outer peripheral edge of the base, the base does not need to be made larger than the operation dial as in the prior art, and an operation input device with small floor area can be obtained. Since a large installation space is not required, incorporation can be made to a wide variety of electric devices.

In the above aspect, the push button switch mounted on the print substrate may be operable with a push button, which is coupled and integrated through at least a pair of coupling portions extending inward from an inner peripheral surface of the annular operation plate and which is fitted to an operation hole of a ring-shaped fixing tool.

According to the present embodiment, the operation function increases with increase in the push button, but the installation space does not increase and incorporation can be made to a wider range of electric devices. Furthermore, an operation input device capable of maintaining high productivity can be obtained since the number of components and the number of assemblies do not increase even if the operation function is increased.

In the above aspect, the outer peripheral edge of the push button may be locked to the inner peripheral edge of the ring-shaped fixing tool to prevent slip-out, and the push button switch mounted on the print substrate may be operable with the push button.

According to the present embodiment, the installation space does not increase even if the operation function is increased with increase in the push button, and incorporation can be made to a wider range of electric devices.

In the above aspect, a pin hole for receiving an assembly pin may be arranged at a pair of assembly projections arranged in a projecting manner at opposing positions of the inner peripheral surface of the ring-shaped fixing tool.

According to the present embodiment, the assembly task of the ring-shaped fixing tool is facilitated, and the productivity enhances.

In accordance with another aspect of the present invention, an electronic device in which the operation input device according to above aspects is attached with the operation dial exposed to be externally operable.

According to the present invention, a small electronic device with satisfactory yield can be obtained by incorporating the operation input device with small installation space that is less likely to be damaged.

### BRIEF DESCRIPTION OF THE DRAWINGS

FIGS. 1A and 1B are perspective views of a first embodiment of an operation input device according to the present invention seen from different angles;

FIG. 2 is an exploded perspective view of the operation input device shown in FIG. 1A;

FIG. 3 is an exploded perspective view seen from the upper side when one part of the operation input device shown in FIG. 2 is further exploded;

FIGS. 4A and 4B are exploded perspective views seen from different angles when one part of the operation input device shown in FIG. 2 is exploded;

FIG. 5 is an exploded perspective view of the operation input device shown in FIG. 1B;

FIG. 6 is an exploded perspective view seen from the lower side when one part of the operation input device shown in FIG. 5 is further exploded;

FIG. 7A is a bottom view of the operation input device shown in FIG. 1, and FIG. 7B is a longitudinal cross-sectional view taken along line B-B in FIG. 7A;

FIGS. 8A and 8B are longitudinal cross-sectional views taken along line VIIIA-VIIIA and line VIIIB-VIIIB of the operation input device shown in FIG. 7A;

FIG. 9A is a bottom view of the operation input device shown in FIG. 1, and FIG. 9B is a longitudinal cross-sectional view taken along line B-B shown in FIG. 9A;

FIGS. 10A and 10B are perspective views of a second embodiment of the operation input device according to the present invention seen from different angles;

FIG. 11 is an exploded perspective view seen from the upper side when one part of the operation input device shown in FIG. 10A is exploded;

FIG. 12 is an exploded perspective view seen from different angles when one part of the operation input device shown in FIG. 11 is further exploded;

FIGS. 13A and 13B are exploded perspective views seen from different angles when one part of the operation input device shown in FIG. 11 is exploded;

FIG. 14 is an exploded perspective view seen from the lower side when one part of the operation input device shown in FIG. 10B is exploded;

FIG. 15 is a perspective view seen from the lower side when one part of the operation input device shown in FIG. 11 is further exploded;

FIG. 16A is a bottom view of the operation input device shown in FIGS. 10A and 10B, and FIG. 16B is a longitudinal cross-sectional view taken along line B-B shown in FIG. 16A;

FIGS. 17A and 17B are longitudinal cross-sectional views taken along line VIIA-VIIA and line VIIB-VIIB of the operation input device shown in FIG. 16A; and

FIG. 18A is a bottom view of the operation input device shown in FIG. 10, and FIG. 18B is a longitudinal cross-sectional view taken along line B-B shown in FIG. 18A.

### DETAILED DESCRIPTION

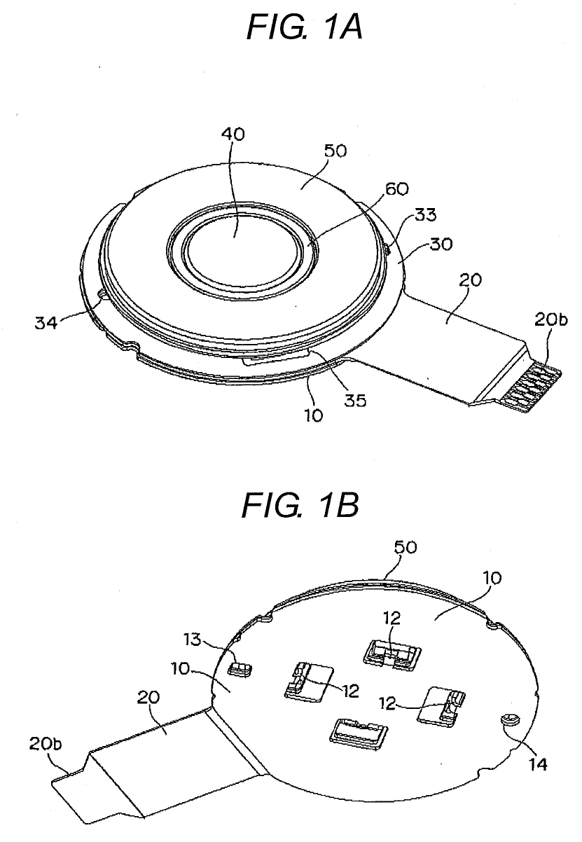

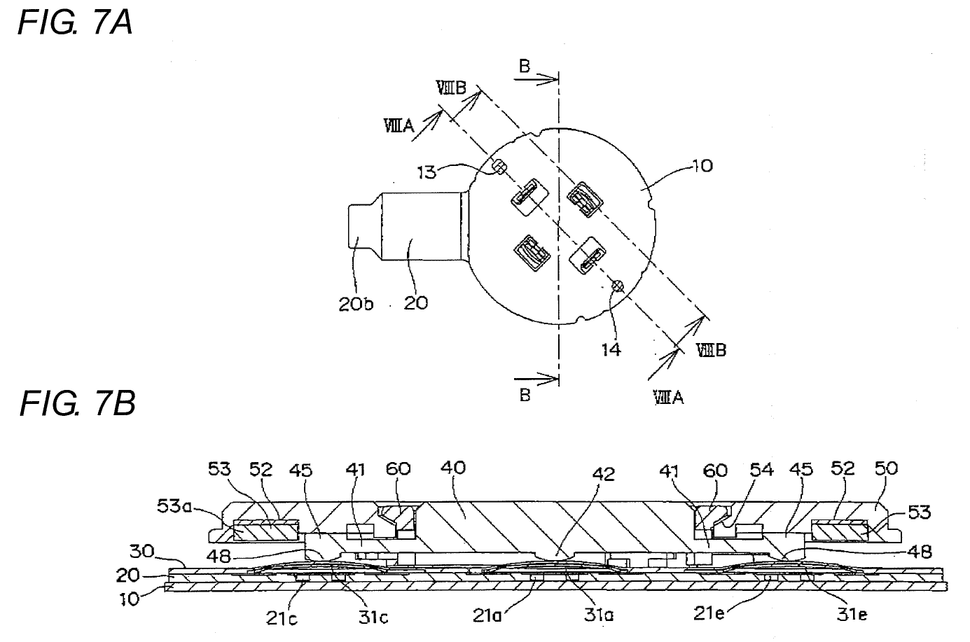

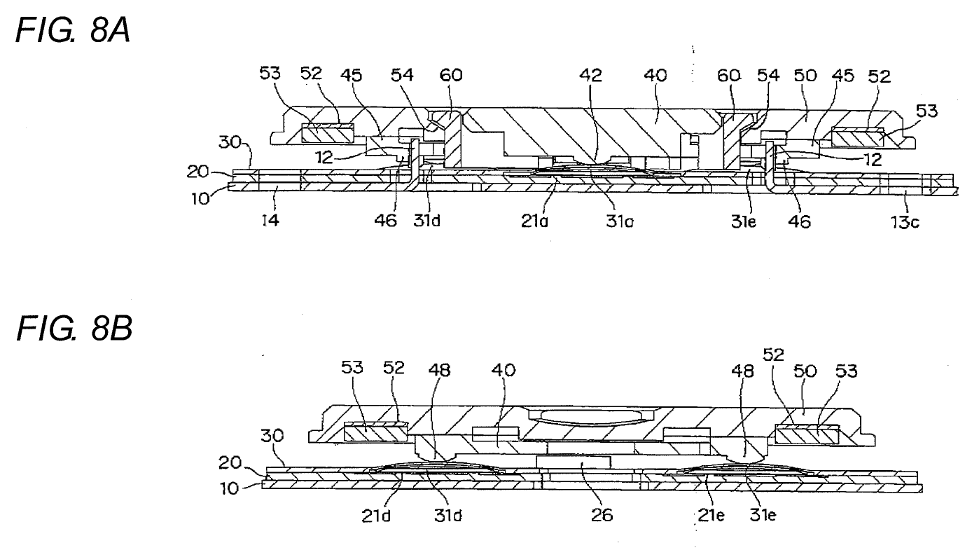

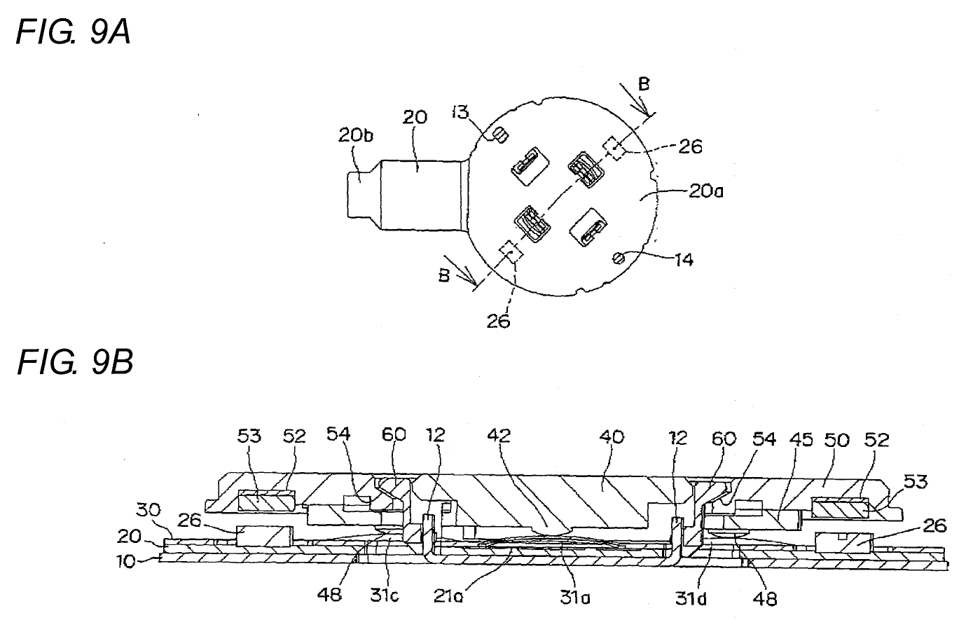

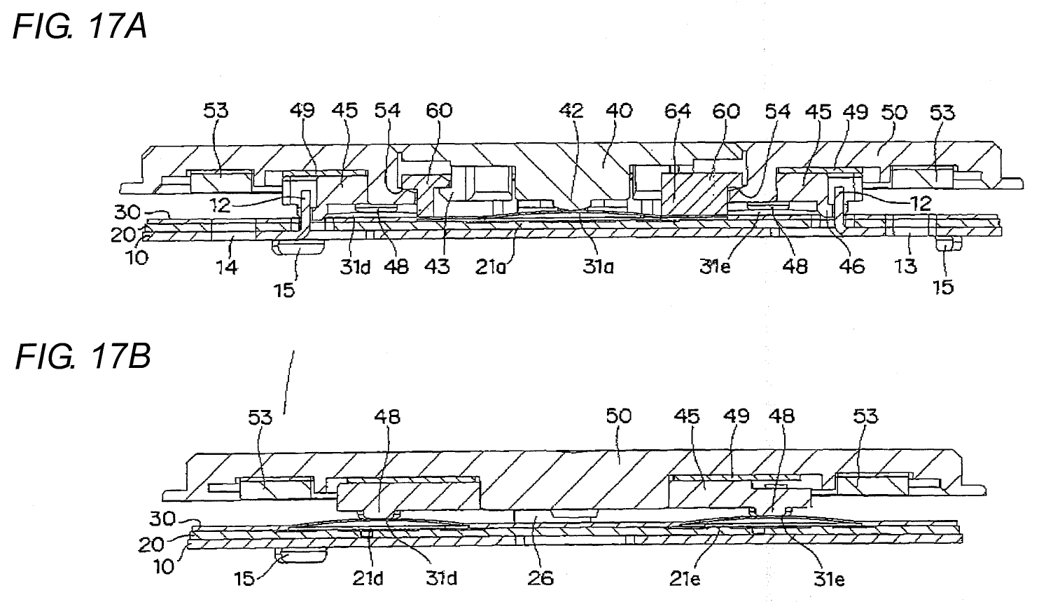

Hereinafter, preferred embodiments of the present invention will be described with reference to the accompanied drawings FIGS. 1 to 18.

The operation input device according to the first embodiment is incorporated in the mobile phone (not shown), so that the scroll bar in the monitor can be scrolled, and the selection instruction can be given through a push button 40, and the like, to be described later.

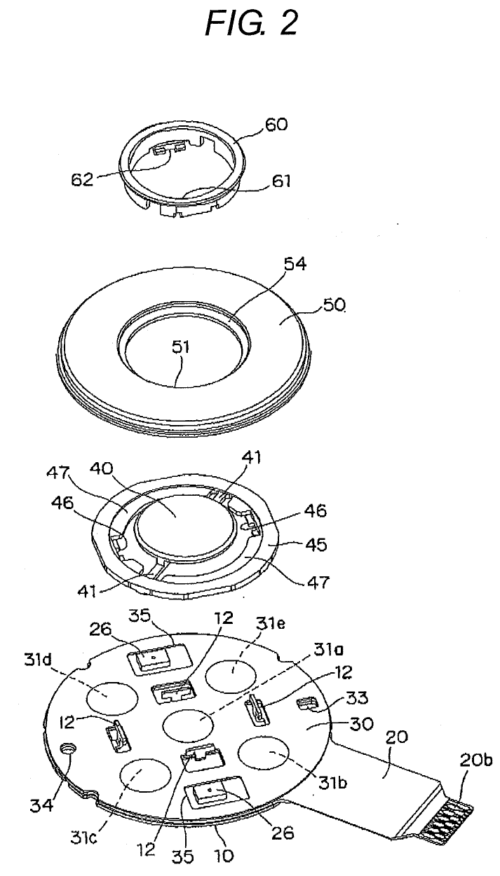

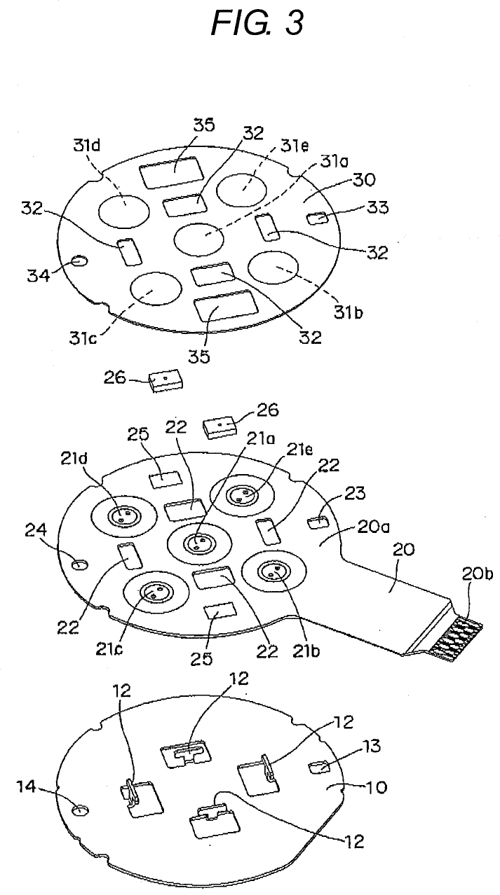

As shown in FIGS. 2 and 3, the operation input device includes a metal base 10 adhered and integrated with a flexible print substrate 20, a resin film cover 30 having a central push button switch 31a and four push button switches 31b to 31e, which are made of a dome-shaped movable contact, attached at the lower surface, a push button 40 for operating the central push button switch 31a, an annular operation plate 45 mounted on the push button switches 31b to 31e, an operation dial 50 having an annular magnet 53 fixed to the lower surface, and a ring-shaped fixing tool 60 for fixing the operation dial 50 to the metal base 10 to prevent slip-out.

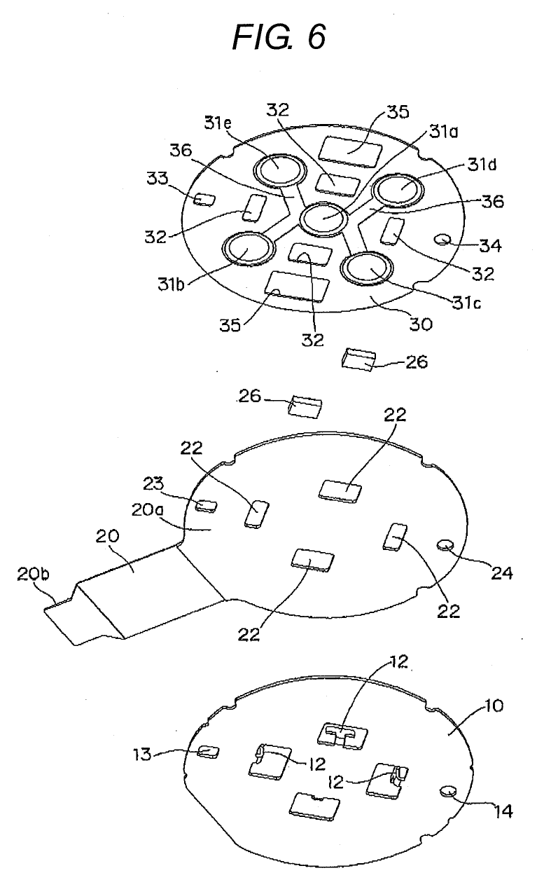

As shown in FIGS. 3 and 6, the metal base 10 is substantially circular in plane, where four substantially T-shaped elastic engagement receiving portions 12 are raised at an equal pitch on the same circumference from the center. Among such elastic engagement receiving portions 12, jig holes 13, 14 are arranged on the outer side of a pair of opposing elastic engagement receiving portions 12, 12, respectively.

The print substrate 20 made of flexible resin film is formed by a substantially circular substrate main body 20a having an adhesive material applied to the back surface, and a lead portion 20b extending from the substrate main body 20a. The substrate main body 20a has a conductive portion 21a arranged at the middle, and conductive portions 21b to 21e are arranged at an equal pitch on the same circumference with the conductive portion 21a as the center. The conductive portions 21a to 21e include an annular fixed contact portion and a pair of fixed contact portions arranged within the annular fixed contact portion. The print substrate 20 includes an engagement hole 22 and jig holes 23, 24 at positions corresponding to the elastic engagement receiving portion 12 and the jig holes 13, 14 of the metal base 10. Furthermore, the substrate main body 20a is formed with installing portions 25, 25 for electrically connecting a Hall element 26, to be described later, at the outer peripheral edge. The Hall element 26 has a property of outputting a detection signal in response to the magnetic flux passing above. The print substrate 20 has the Hall element 26 positioned and connected to the installing portion 25.

The conductive portions 21a to 21e may be such that the fixed contact portion is concentric, or another fixed contact portion may be arranged at the middle of one fixed contact portion having a substantially C-shape in plan view.

The resin film cover 30 has a planar shape that can cover the substrate main body 20a, where the push button switches 31a to 31e including a flat dome-shaped inversion spring are attached at the positions corresponding with the conductive portions 21a to 21e of the back surface applied with the adhesive material (FIG. 6). The push button switches 31a to 31e are formed with a vent portion 36 for communicating the push button switches 31a to 31e to each other at the back surface of the substrate main body 20a to reduce the air resistance at the time of pushing. Furthermore, the resin film cover 30 includes the engagement hole 32 and the jig holes 33, 34 at the positions corresponding to the elastic engagement receiving portion 12 and the jig holes 13, 14 of the metal base 10. The resin film cover 30 is formed with an escape portion 35 for fitting the Hall element 26 at the outer peripheral edge.

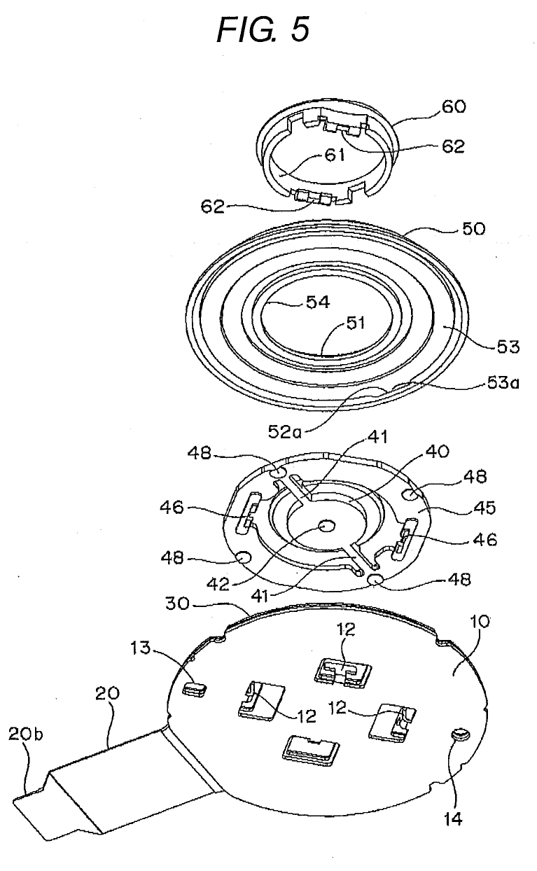

As shown in FIGS. 2 and 5, the push button 40 has an outer peripheral shape that can be fitted to a fit-in hole 51 of the operation dial 50, to be described later, and is integrated to the inner peripheral surface of the operation plate 45, to be described later, through a pair of coupling portions 41, 41 extending on the same axial center from the outer peripheral edge. The push button 40 includes an operation projection 42 for pushing down the push button switch 31a at the central part of the bottom surface.

The operation plate 45 has a concentric shape having a diameter that can be mounted on the push button switches 21b to 21e, and includes engagement portions 46, 46 engageable to the elastic engagement receiving portion 12 of the metal base 10 at the opposing positions of the inner peripheral edge of the lower surface. The operation plate 45 has a discontinuous reinforcement rib 47 (FIG. 2) arranged in a projecting manner at the inner peripheral surface, and an operation projection 48 for pushing the push button switches 21b to 21e arranged in a projecting manner at the outer peripheral edge of the lower surface.

The operation plate 45 may have a slidably moving sheet for smoothly carrying out the turning operation of the operation dial 50, to be described later, adhered and integrated at the upper surface, may have a resin material having a small friction resistance applied, or may be performed with a pear-skin finished processing to reduce the friction resistance.

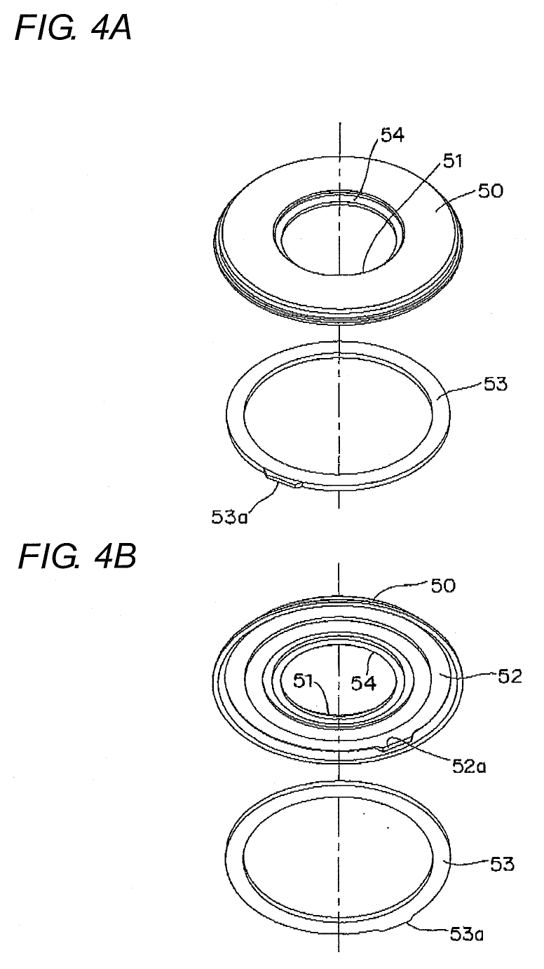

As shown in FIGS. 4A and 4B, the operation dial 50 has a concentric shape that can mount the metal base 10, and includes the fit-in hole 51, to which the push button 40 can be fitted, at the center. The operation dial 50 includes an annular groove 52 along the outer peripheral edge of the lower surface, and includes a cutout portion 52a communicating to the annular groove 52. Furthermore, an annular step portion 54 is formed at the edge on the lower side of the fit-in hole 51. The annular magnet 53 is fixed to the annular groove 52 by fitting a burr portion 53a of the annular magnet 53 to the cutout portion 52a. The operation dial 50 does not necessarily need to be circular, and may be a regular octagon shape as long as it is turnable.

As shown in FIGS. 2 and 5, the ring-shaped fixing tool 60 has a ring portion formed to a substantially L-shape in cross-section, and has an outer diameter dimension capable of engaging to and preventing the slip-out of the annular step portion 54 of the operation dial 50 by being fitted to the fit-in hole 51 of the operation dial 50. The ring-shaped fixing tool 60 includes an operation hole 61 having an inner diameter dimension capable of fitting the push button 40. Furthermore, the ring-shaped fixing tool 60 includes an engagement portion 62 that can elastically engage to the elastic engagement receiving portion 12 of the metal base 10 at the opposing position of the edge on the lower side.

The assembly step of the components described above will now be described.

First, the jig holes 13, 14 of the metal base 10 are inserted to a pair of positioning pins, which is a jig (not shown), for positioning. The jig holes 23, 24 of the print substrate 20 having the Hall elements 26, 26 mounted on a predetermined position are inserted to the pair of pins of the jig to fit the engagement hole 22 of the print substrate 20 to the elastic engagement receiving portion 12 of the metal base 10, and adhere and integrate the same. Furthermore, by inserting the jig holes 33, 34 of the resin film cover 30 to the jig pins, the resin film cover 30 is adhered and integrated to the main body 20a of the print substrate 20 to position the push button switches 31a to 31e made of dome-shaped inversion spring to the conductive portions 21a to 21e.

The push button 40 is then mounted on the push button switch 31a, and the engagement portions 46, 46 of the operation plate 45 are engaged to the elastic engagement receiving portion 12, 12 of the base, so that the operation plate 45 is contacted to and positioned on the push button switches 31b to 31e. The fit-in hole 51 of the operation dial 50 is then fitted to the push button 40. Furthermore, the ring-shaped fixing tool 60 is inserted to between the push button 40 and the operation dial 50, and the engagement portions 62, 62 of the ring-shaped fixing tool 60 are elastically engaged to the elastic engagement receiving portions 12, 12 of the metal base 10. Thus, the operation dial 50 is prevented from slipping out by engaging the ring-shaped fixing tool 60 to the step portion 54 of the operation dial 50.

The method of fixing the ring-shaped fixing tool 60 with respect to the metal base 10 is not limited to elastic engagement, and may be caulking fixation or welding fixation.

According to the present embodiment, the push button 40 and the operation plate 45 mounted on the push button switches 31a to 31e are biased upward by the spring force of the dome-shaped inversion spring. Thus, rattling does not occur in the up and down direction, over-turning of the operation dial 50 by force of inertia is suppressed, and false operation does not occur.

Furthermore, the push button 40, the operation dial 50, and the ring-shaped fixing tool 60 do not need to be temporarily held by the metal base 10 and may be sequentially assembled from one direction, and the operation plate 45 and the ring-shaped fixing tool 60 may be fixed to the metal base 10 with one touch. Thus, an operation input device with easy assembly task and excellent productivity can be obtained.

The operation method of when the operation input device having the above configuration is applied to the mobile phone (not shown) will be described below.

When the operation dial 50 is turned with the axial center of the ring-shaped fixing tool 60 as the center, the operation dial 50 turns while slidably contacting the operation plate 45 and the ring-shaped fixing tool 60. Furthermore, the annular magnet 53 integral with the operation dial 50 turns, and the pair of Hall elements 26 respectively detect change in the magnetic field, so that the turning direction and the turning amount are detected based thereon.

Such detection result is reflected on the screen display of the monitor through the control circuit (not shown) as movement of the scroll bar. The push button 40 is pushed when the scroll bar reaches the desired position, so that the inversion spring of the central push button switch 31a is inverted to conduct the corresponding conductive portion 21a and output the selection command.

The peripheral portion of the operation dial 50 may be pushed down and the inversion spring of the push button switches 31b to 31e may be appropriately inverted with the pushing projection 48 of the operation plate 45 to conduct the corresponding conductive portion 21b to 21e.

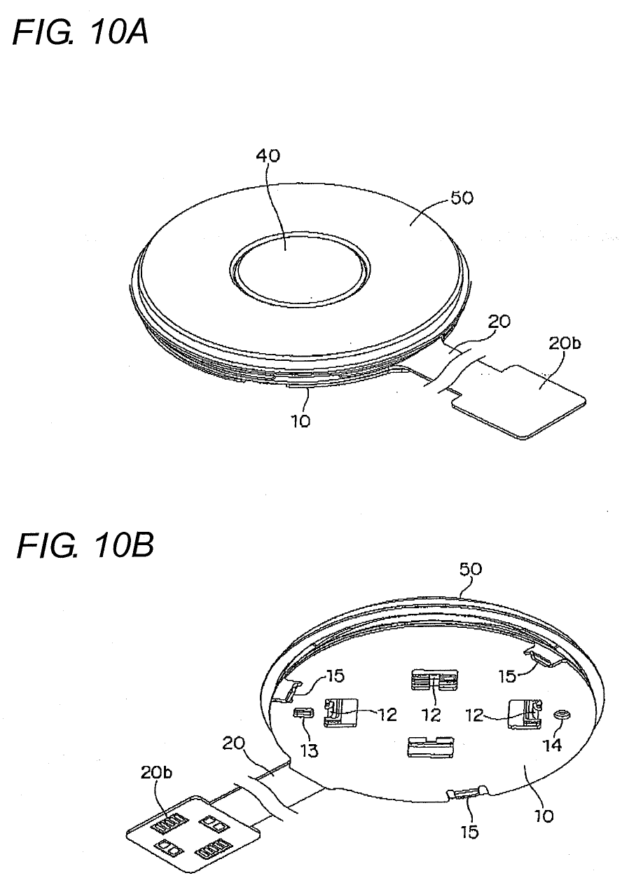

As shown in FIGS. 10 to 18, the second embodiment is substantially similar to the first embodiment in the basic structure, but greatly differs in that the operation button 40 and the operation plate 45 are separate bodies.

Similar to the first embodiment, the second embodiment includes the metal base 10 adhered and integrated with the flexible print substrate 20, the resin film cover 30 having the central push button switch 31a and four push button switches 31b to 31e made of dome-shaped movable contact attached to the lower surface, the push button 40 for operating the central push button switch 31a, the annular operation plate 45 mounted on the push button switches 31b to 31e, the operation dial 50 having the annular magnet 53 fixed to the lower surface, and the ring-shaped fixing tool 60 for fixing the operation dial 50 to the metal base 10 to prevent slip-out.

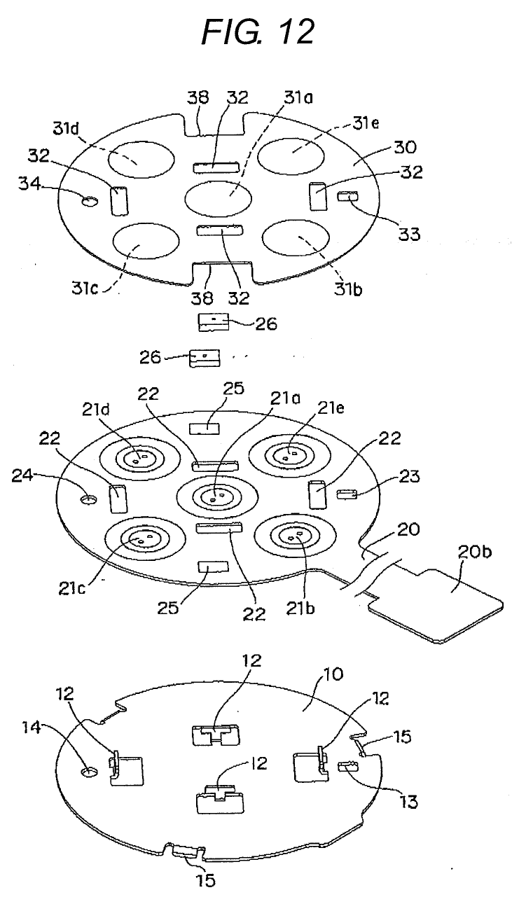

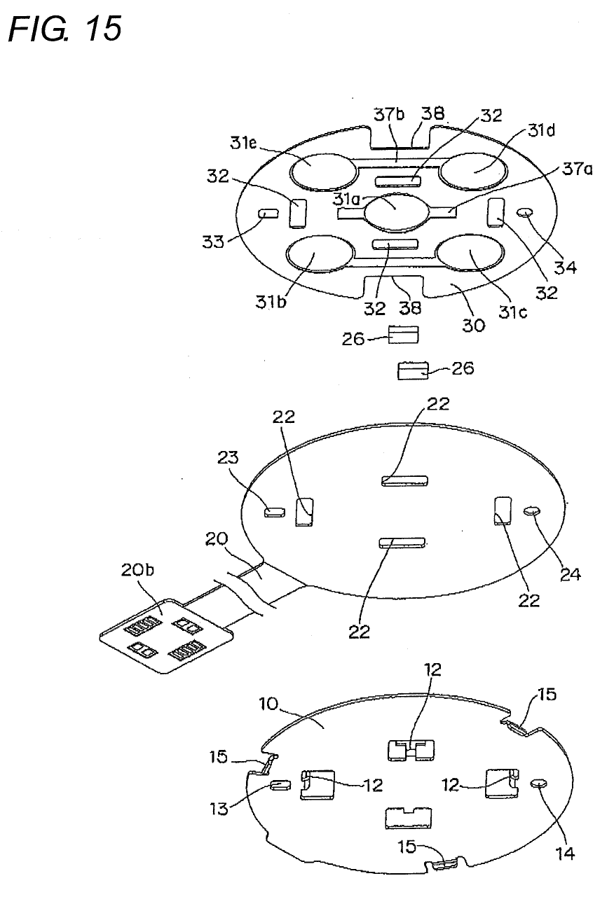

As shown in FIGS. 12 and 15, the metal base 10 is substantially circular in plane, where four substantially T-shaped elastic engagement receiving portions 12 are raised at an equal pitch on the same circumference from the center. Among such elastic engagement receiving portions 12, jig holes 13, 14 are arranged on the outer side of a pair of opposing elastic engagement receiving portions 12, 12, respectively. The metal base 10 also has the engagement nail 15 for assembling to the device main body bent downward at the outer peripheral edge.

The print substrate 20 made of flexible resin film is similar to the first embodiment, and thus the description will be omitted with the same reference numbers denoted for the same portions.

The resin film cover 30 has a planar shape that can cover the substrate main body 20a, where the push button switches 31a to 31e including a flat dome-shaped inversion spring are attached at the positions corresponding with the conductive portions 21a to 21e of the back surface applied with the adhesive material (FIG. 15). The push button switches 31a to 31e have vent portions 37a, 37b communicating to the push button switches 31a to 31e at the back surface of the substrate main body 20a to reduce the air resistance at the time of pushing. Furthermore, the resin film cover 30 includes the engagement hole 32 and the jig holes 33, 34 at the positions corresponding to the elastic engagement receiving portion 12 and the jig holes 13, 14 of the metal base 10. The resin film cover 30 is formed with a cutout portion 38 so as not to cover the Hall element 26 at the outer peripheral edge.

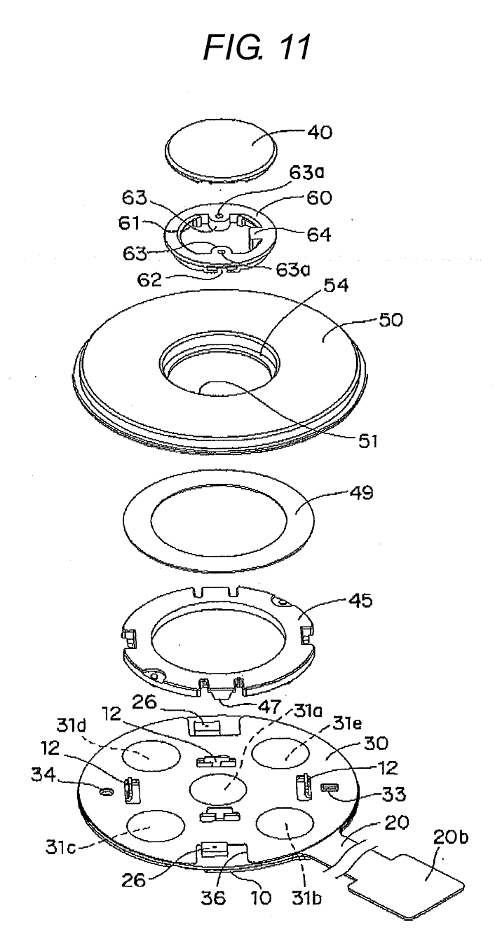

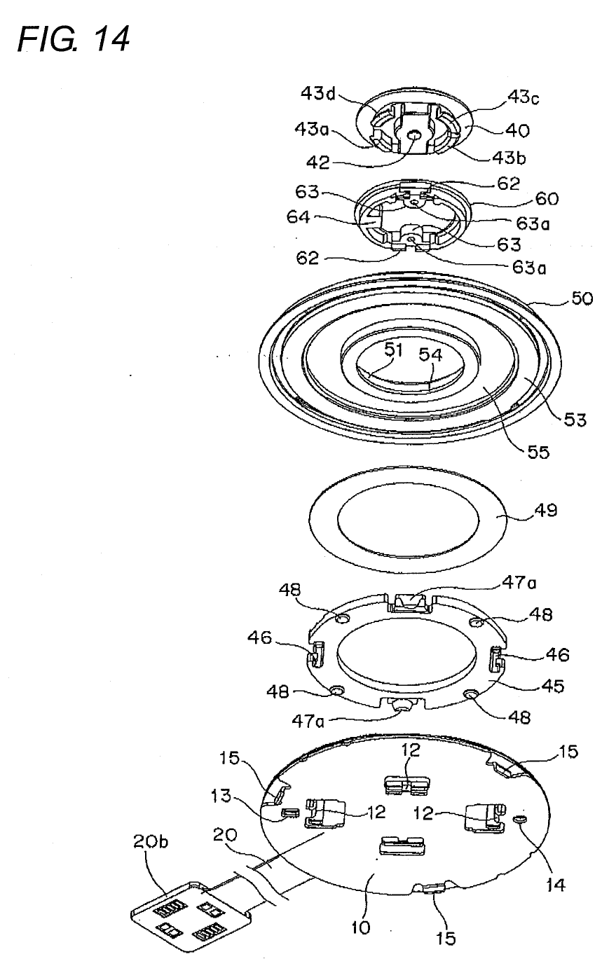

As shown in FIGS. 11 and 14, the push button 40 has an outer peripheral shape that can be fitted to a fit-in hole 51 of the operation dial 50, to be described later, and includes an operation projection 42 for pushing down the push button switch 31a at the central part of the bottom surface. The push button 40 includes, in a projecting manner, four discontinuous curved elastic engagement nails 43a to 43d on the same circumference having the operation projection 42 as the center at the bottom surface.

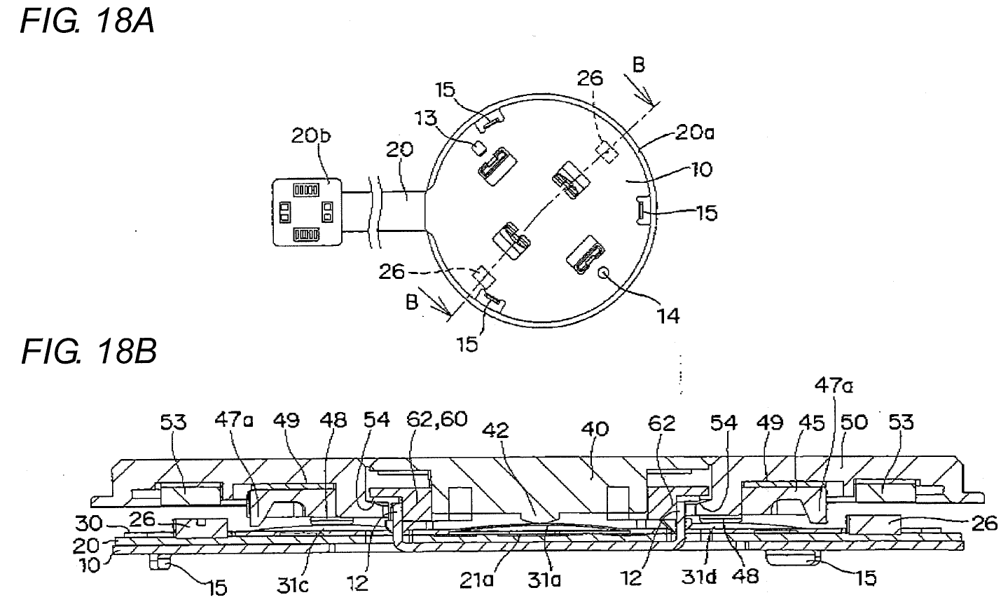

The operation plate 45 has a concentric shape having a diameter that can be mounted on the push button switches 31b to 31e, and includes engagement portions 46, 46 engageable to the elastic engagement receiving portion 12 of the metal base 10 at the opposing positions of the outer peripheral edge of the lower surface. The operation plate 45 includes the operation projection 48 for pushing the push button switches 31b to 31e at a predetermined pitch at the outer peripheral edge of the lower surface. Furthermore, the operation plate 45 includes a cutout groove at the opposing position of the outer peripheral edge, and is formed with a protective projection 47a having a substantially L-shaped cross-section. As shown in FIG. 18B, the protective projection 47a prevents impact between the magnet 53 and the Hall IC 26 as the protective projection 47a receives the impact force when the impact force is applied from above to the operation dial 50 to be described later.

The operation plate 45 has a slidable sheet 49 for smoothly performing the turning operation of the operation dial 50, to be described later, adhered and integrated at the upper surface, but a resin material of small friction resistance may be applied or a pear-skin finished processing may be performed to reduce the friction resistance.

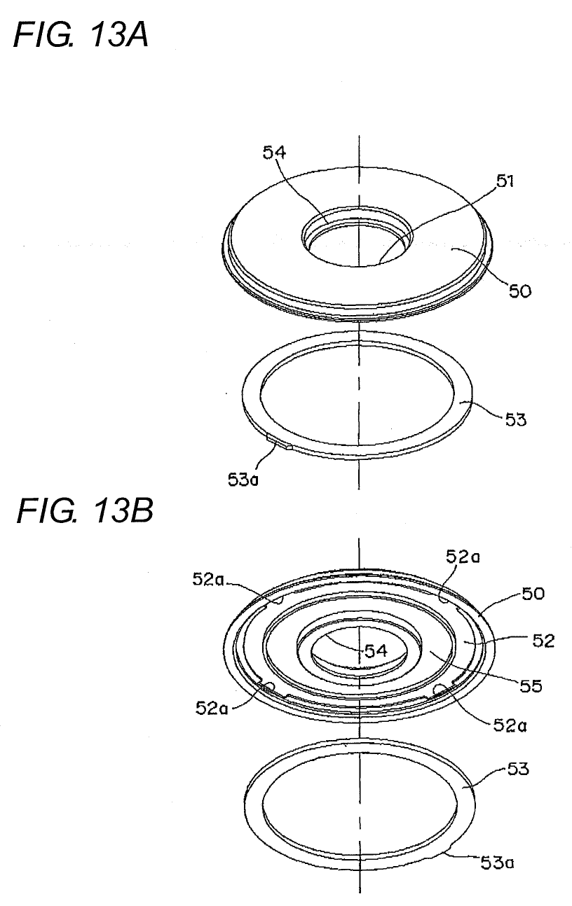

As shown in FIGS. 13A and 13B, the operation dial 50 has a concentric shape that can cover the metal base 10, and includes the fit-in hole 51, to which the push button 40 can be fitted, at the center. The operation dial 50 includes an annular groove 52 along the outer peripheral edge of the lower surface, and includes four cutout portions 52a communicating to the annular groove 52 at a predetermined pitch. Furthermore, an annular step portion 54 is formed at the edge on the lower side of the fit-in hole 51. A slidably contacting groove 55 is formed on a concentric circle on the inner side of the annular groove 52.

Therefore, the annular magnet 53 is fixed to the operation dial 50 by fitting a burr portion 53a of the annular magnet 53 to one of the cutout portions 52a, and injecting and solidifying the adhesive agent in the remaining cutout portions 52a. The operation dial 50 does not necessarily need to be circular, and may be a regular octagon shape as long as it is turnable.

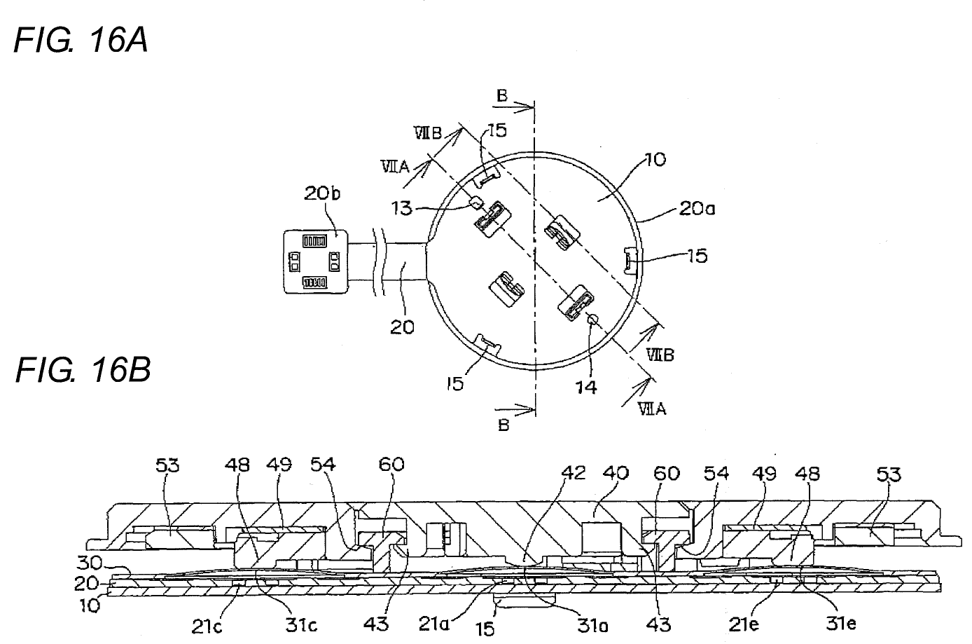

As shown in FIGS. 11 and 14, the ring-shaped fixing tool 60 has a ring portion formed to a substantially T-shape in cross-section (FIG. 16B), and has an outer diameter dimension capable of engaging to and preventing the slip-out of the annular step portion 54 of the operation dial 50 by being fitted to the fit-in hole 51 of the operation dial 50. The ring-shaped fixing tool 60 includes an operation hole 61 having an inner diameter dimension capable of fitting the push button 40 on the inner peripheral surface. Furthermore, the ring-shaped fixing tool 60 includes an engagement portion 62 that can elastically engage to the elastic engagement receiving portion 12 of the metal base 10 at the opposing position of the edge on the lower side. The ring-shaped fixing tool 60 includes, in a projecting manner, an assembly projection 63 on the inner side surface positioned immediately above the engagement portion 62, and includes a positioning projection 64, in a projecting manner, on the inner side surface positioned between the assembly projections 63, 63. The assembly projection 63 includes a pin hole 63a for receiving an assembly pin (not shown).

The assembly step of the components described above will now be described.

First, the jig holes 13, 14 of the metal base 10 are inserted to a pair of positioning pins, which is a jig (not shown), for positioning. The jig holes 23, 24 of the print substrate 20 having the Hall elements 26, 26 mounted on a predetermined position are inserted to the pair of pins of the jig to fit the engagement hole 22 of the print substrate 20 to the elastic engagement receiving portion 12 of the metal base 10, and adhere and integrate the same. Furthermore, the jig holes 33, 34 of the resin film cover 30 are inserted to the jig pin and the resin film cover 30 is adhered and integrated to the main body 20a of the print substrate 20 to position the push button switches 31a to 31e made of dome-shaped inversion spring to the conductive portions 21a to 21e.

The operation projection 48 is contacted and positioned on the push button switches 31b to 31e by engaging the engagement portions 46, 46 of the operation plate 45 to the elastic engagement receiving portions 12, 12 of the base. The slidable groove 55 of the operation dial 50 is fitted to the annular operation plate 45 through the slidable sheet 49 to be assembled in a freely turning manner. The assembly pin (not shown) is then inserted to the pin holes 63a, 63a of the ring-shaped fixing tool 60. The ring-shaped fixing tool 60 is fitted to the fit-in hole 51 of the operation dial 50 through the assembly pin while being bent inward, and the engagement portion 62 is engaged to the elastic engagement receiving portion 12 to prevent slip-out of the operation dial 50. Lastly, the positioning projection 64 of the ring-shaped fixing tool 60 is fitted to and positioned at between the elastic engagement nail 43a and the elastic engagement nail 43d of the push button 40, and the push button 40 is pushed down. The elastic engagement nails 43a to 43d thus lock to the ring-shaped fixing tool 60, the push button 40 is prevented from slipping out, and the operation projection 42 of the push button 40 contacts the push button switch 31a.

The method of fixing the ring-shaped fixing tool 60 to the metal base 10 is not limited to elastic engagement, and may be caulking fixation or welding fixation.

In the present embodiment, the push button 40 and the operation plate 45 mounted on the push button switches 31a to 31e are biased upward by the spring force of the dome-shaped inversion spring. Thus, rattling does not occur in the up and down direction, over-turning of the operation dial 50 by force of inertia is suppressed, and false operation does not occur.

Furthermore, the operation plate 45, the operation dial 50, the ring-shaped fixing tool 60 and the push button 40 do not need to be temporarily held by the metal base 40 and may be sequentially assembled from one direction, and the operation plate 45, the ring-shaped fixing tool 60, and the push button 40 may be fixed with one touch. Thus, an operation input device with easy assembly task and excellent productivity can be obtained.

The operation method of the operation input device having the above configuration is substantially similar to the operation input device according to the first embodiment, and thus the description will be omitted. However, as shown in FIG. 18B, if an impact load is applied on the operation dial 50 from above, the protective projection 47a of the operation plate 45 receives the impact load thereby preventing impact of the Hall element 26 and the annular magnet 53 and preventing damage of the same. Others are the same as the above-described embodiment, and thus the detailed description will be omitted.

The operation input device according to the present invention is not limited to the mobile phone, and may obviously be applied to other mobile devices and other electronic devices.

1. An operation input device comprising:
a base comprising at least four elastic engagement receiving portions raised at a periphery of a center thereof;
a print substrate configured to be stacked and integrated on the base, the print substrate comprising:
a plurality of push button switches mounted on a circumference thereof; and
a magnetic field detection element mounted thereon;
an annular operation plate mounted on the push button switches of the print substrate and configured to prevent slip-out, the annular operation plate comprising an inner peripheral edge configured to engage with at least two of the elastic engagement receiving portions of the base;
an operation dial mounted on the annular operation plate on an axial center, the operation dial comprising an annular magnet integrated on a concentric circle at a lower surface; and
a fixing tool configured to be inserted to a fit-in hole of the operation hole and engage with at least two of the elastic engagement receiving portions of the base at an edge on a lower side and with the inner peripheral edge of the operation dial; wherein
change in magnetic flux of the annular magnet is detected by the magnetic field detection element when the operation dial is turned, and the push button switch is operated through the operation plate when the operation dial is pushed down.

2. The operation input device according to claim 1, wherein the push button switch mounted on the print substrate is operable with a push button fitted to an operation hole of a ring-shaped fixing tool and coupled and integrated through at least a pair of coupling portions extending inward from an inner peripheral surface of the annular operation plate.

3. The operation input device according to claim 1, wherein the outer peripheral edge of the push button is locked to the inner peripheral edge of the ring-shaped fixing tool, and the push button switch mounted on the print substrate is operable with the push button.

4. The operation input device according to claim 3, wherein a pin hole for receiving an assembly pin is formed on a pair of assembly projections arranged in a projecting manner at opposing positions of the inner peripheral surface of the ring-shaped fixing tool.

5. The operation input device according to claim 1, wherein the operation input device is disposed within an electronic device so that the operation dial is exposed to be externally operable.

6. The operation input device according to claim 2, wherein the operation input device is disposed within an electronic device so that the operation dial is exposed to be externally operable.

7. The operation input device according to claim 3, wherein the operation input device is disposed within an electronic device so that the operation dial is exposed to be externally operable.

8. The operation input device according to claim 4, wherein the operation input device is disposed within an electronic device so that the operation dial is exposed to be externally operable.
